(19) United States
(12) Patent Application Publication
(10) Pub. No.: US 2013/0003653 A1
(43) Pub. Date: Jan. 3, 2013

(54) Method And Apparatus For Facilitating Home Network Access

(75) Inventors: Corey F. Adams, Frisco, TX (US); Michael J. Brehm, Allen, TX (US)

(73) Assignee: Alcatel-Lucent USA Inc., Murray Hill, NJ (US)

(21) Appl. No.: 13/173,961

(22) Filed: Jun. 30, 2011

(51) Int. Cl. H04W 4/00

(52) U.S. Cl. 370/328

(57) ABSTRACT

A manner of extending a home network to a mobile device. An SG (signaling gateway) is provided to receive register an HA (home agent) and an FA (foreign agent) and form a secure tunnel to each to form a communication channel. A heartbeat may be exchanged with the HA to keep open the NAT boundary for the communication channel. If a high bandwidth application request is received from the HA, the SG determines if there is a PS (proxy server) able to handle the session and, if so, transfers the channel.

### CROSS-REFERENCE TO RELATED APPLICATIONS

The present disclosure is related to and claims priority from U.S. patent application Ser. No. 12/985,730 entitled Method and Apparatus for Home Network Access and filed Mar. 23, 2010, which in turn claims priority to U.S. Provisional Patent Application Ser. No. 61/316,553, entitled Extending the In-Home Layer 2 Network and filed on 23 Mar. 2010 the entire contents of which applications are incorporated in their entirety by reference herein. The present disclosure is also related to U.S. patent application Ser. No. 12/986,706 entitled Method and Apparatus for Home Networking Access Using a Remote Mobile Device and filed Jan. 7, 2011; U.S. patent application Ser. No. 13/077,633 entitled Method and Apparatus for Home Networking Access by a Trusted Monitoring Agent and filed Mar. 31, 2011; and U.S. patent application Ser. No. 13/075,920 entitled Method and Apparatus for Enhancing QoS During Home Network Remote Access and filed Mar. 30, 2011; the entire contents of which applications are incorporated in their entirety by reference herein.

### TECHNICAL FIELD

The present invention relates generally to the field of communication networks, and, more particularly, to a method and apparatus for facilitating remote access by a subscriber to an in-home communication network.

### BACKGROUND

Introductory information will here be provided. Note, however, that the apparatus, techniques, or schemes described herein as existing or possible are presented only as background for describing the present invention, and no admission is intended thereby that these were heretofore commercialized or known to others beside the inventors.

Selected abbreviations are herewith defined, at least some of which are referred to within the following description of the state-of-the-art and the present invention.

### ASIC Application Specific Integrated Circuit

### BSS Business Support Systems

### CAC Call Admission Control

### CRL Certificate Revocation List

### DHCP Dynamic Host Configuration Protocol

### DSL Digital Subscriber Line

### DVR Digital Video Recorder

### HA Home Agent

### FA Foreign Agent

### IEEE Institute of Electrical and Electronics Engineers

### IP Internet Protocol

### ISP Internet Service Provider

### NAT Network Address Translation

### OS Operating System

### OSS Operations Support Systems

### PC Personal Computer

### PKI Public Key Infrastructure

### PS Proxy Server

### RG Residential Gateway

### SG Signaling Gateway

### QoS Quality of Service

### TCP Transmission Control Protocol

### UID Unique Identifier

Consumer electronics have progressed a great deal in the recent past. Not only are they more capable than they were a short time ago, they are also far more prevalent. Many homes, for example, have more than one personal computer and video storage device, along with many similar devices. These devices are often connected together to form a network, and through the network are capable of communicating with other devices outside of the home. The use of email and telephone services that are available through such networks is very common, and the downloading of, for example, software applications and multimedia transmissions is becoming more frequent.

A home network benefits users in a number of ways. Even if there is no connection to others outside of the home, the home network allows a user to, for example, print from a printer that is not connected directly to the computer in use. Files such as documents, pictures, and videos may be retrieved or sent to another device within the home. Modern data storage units are capable of saving a large amount of audio or video data, and the network permits this content to be retrieved and played on any device connected to the network. Multiple users may participate in a game over the network.

Connections outside of the home are often facilitated by some type of device that serves as an interface to whatever network service is providing access. Such a device may take the form, for example, of a wireless router connecting multiple computers to the Internet, or a set-top box that receives video and television programming for display on a television or other video display device. Many if not most home networks are connected to an access network, which provides a link between a subscriber's home and a core network capable of handling large amounts of communication traffic and providing gateways for communicating through other networks as well.

When the home network is connected to an access network, communications such as email and Internet access are permitted; video and audio content may be downloaded. In addition, recent advances in technology have enlarged the amount of data that may be uploaded, or sent from the home network to others through the access network. In some cases, for example a movie or other video may be sent to another at nearly the speed at which it was downloaded, at least from the user's perception.

This may be of great advantage to the user of a mobile device. As used herein, a mobile device is one capable of accessing a mobile network using radio communications. Mobile devices are very popular because of their mobility; a user may conveniently carry the device with them and use it anywhere a mobile network may be contacted. Mobile network providers have signed up thousands of subscribers and built up networks that cover large geographic areas. In many locations, if a subscriber cannot access their own mobile network, they may use another network as a visitor. Mobile networks are often based on a cell system, where mobile devices communicate with a nearby base station and handover protocols allow them to travel from one cell (base station) to another without significant interruption of an on-going communication session.

A mobile subscriber at home may be able to access content and devices that are part of the home network, for example using a short range radio protocol such as Bluetooth. When the user is not at home, however, such access is not available, but the content may be accessible in a number of other ways. For example, content accessible via the home network may not actually be stored there, but is rather stored in a remote memory device maintained by a vendor. In other cases the content may be stored within the home network, but is copied or mirrored at a vendor's server for the purpose of providing mobile access. In either case, the user may access the content being stored by the vendor using a mobile device communicating though a mobile network.

There are disadvantages with this strategy, however. For one, storage on a vendor site may raise security concerns. In addition, the vendor may charge for the service and there is a risk that they may at some point become unavailable if their business fails. Finally, the sheer volume of content that users currently want to, and are projected to demand, may make this option less than viable in the future.

Access may also be possible directly to the home network though a mobile network using protocols such as MobileIP. In such an arrangement it is contemplated that the mobile device embodies a foreign agent (FA) that establishes a communication session with a home agent (HA) embodied on one of the devices that makes up the home network. Although this addresses some of the disadvantages associated with third party vendors, several disadvantages remain.

First, to communicate with the FA, the HA obtains an IP address. In general practice, however, this IP address will be dynamically assigned, meaning that the address is not assigned permanently but will eventually be re-assigned to another user. Of course, the HA can request another IP address, but when assigned it will almost certainly be different than the previous one. While the policy of dynamically assigning IP addresses conserves IP addresses and reduces the number ultimately required, it can disrupt routing between the FA and the HA and make it more difficult for the mobile device to register with its respective HA.

In addition, home networks frequently employ a residential gateway, with the HA being assigned a private IP address and being behind a NAT boundary. This also may help to conserve IP addresses, but may make it difficult for the FA to contact the HA and set up a secure tunnel for communications.

In the face of such difficulties, there is a need for a manner of facilitating secure access to a home network from a remote mobile station. Accordingly, there has been and still is a need to address the aforementioned shortcomings and other shortcomings associated with communications between a FA embodied in a mobile device and an HA in a home network. These needs and other needs are satisfied by the present invention.

### SUMMARY

The present invention is directed to a manner of facilitating access to a home network by a mobile device. In one aspect, the present invention is a method of providing remote access via an SG (signaling gateway) for a mobile device comprising an FA (foreign agent) to a home network comprising an HA (home agent), including receiving a registration request from an HA at the SG, registering the HA, receiving a heartbeat message from the HA at the SG, responding to the heartbeat message, receiving a request directed to the HA from an FA, and registering the FA. In a preferred embodiment the registration of the HA or of the FA, or both, includes executing an authentication protocol and recording the registration in, respectively, an HA-UID or an FA_UID table or register. The method may also include entering the FA-HA pair into an FA-HA pair table at the SG. A secure is thereby established between the FA and the SG and between the HA and the SG, with the SG forwarding communications in both directions.

In some embodiments, prior to registering the FA in the SG, a determination is made as to whether the HA to which the FA communication is directed has been registered with the SG. If not, the FA registration may be denied. In addition, a query may also be made to the target HA to confirm that communication with the FA is desired.

In some embodiments, the SG may operate in a distribute-server environment with one or more other SGs and, if so, the method may further include distributing the registration and pair information to the other SGs.

If a request is received from the HA to execute an application requiring significant bandwidth, the SG may transfer the communication pair to a proxy server (PS). Before doing so, the SG may determine whether the anticipated bandwidth of the application execution exceeds allowable limits. It may communicate with the OSS/BSS of the communication network for this purpose. The SG may also query one or more PSs prior to attempting a transfer to confirm that the communication session will be accepted by the PS.

In another aspect, the present invention is a signaling gateway (SG) including a processor, a memory device accessible to the processor, a heartbeat message generator for responding to a received heartbeat message, and an FA-HA pair table for registering an FA-HA communication pair during a communication session. In a preferred embodiment, the SG includes a mobile network interface for communicating with FAs via a mobile network and a separate home network interface for communicating with HAs via an access network. The SG amy also include a load balancer for determining when to transfer an FA-HA pair to another SG in a distributed-server environment.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a home network according to an embodiment of the invention;

FIG. 2 is a simplified schematic diagram illustrating selected components of a communication network according to an embodiment of the present invention;

FIG. 3 is a flow diagram illustrating a method according to an embodiment of the present invention;

FIG. 4 is a flow diagram illustrating a method according to an embodiment of the present invention;

FIG. 5 is a flow diagram illustrating a method according to an embodiment of the present invention; and

FIG. 6 is a simplified schematic diagram illustrating selected components of an SG according to an embodiment of the present invention.

### DETAILED DESCRIPTION

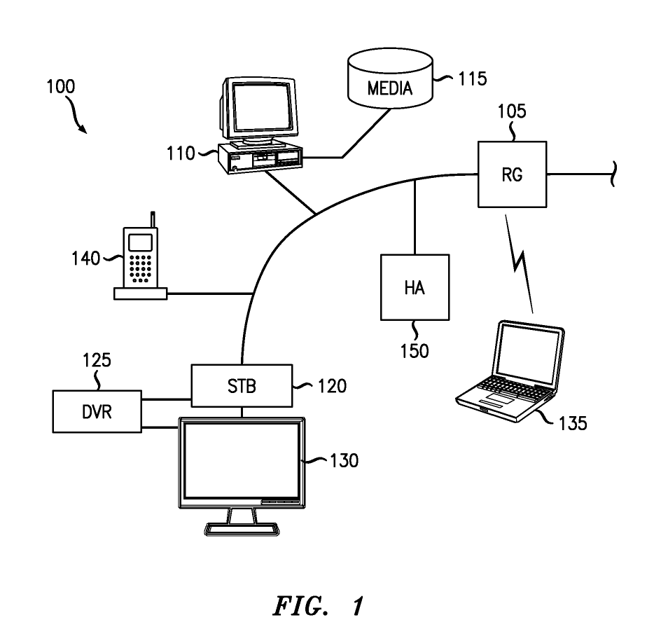

The present invention is directed to a manner of extending a home network to a remote mobile device, and is of particular advantage when implemented in an environment where communication with the home network is limited by a dynamic connection point to the Internet and a NAT (network address translation) boundary FIG. 1 is a simplified schematic diagram illustrating selected components of a home network 100 according to an embodiment of the invention. Note that the home network is so-called because the components used are suitable to acquisition and use in-home by a subscriber, but the same system could just as easily be installed in, for example, a small business, school, or church office setting. For convenience, such a network will be referred to as a home network regardless of whether it is installed in the residence of a single subscriber or in another location.

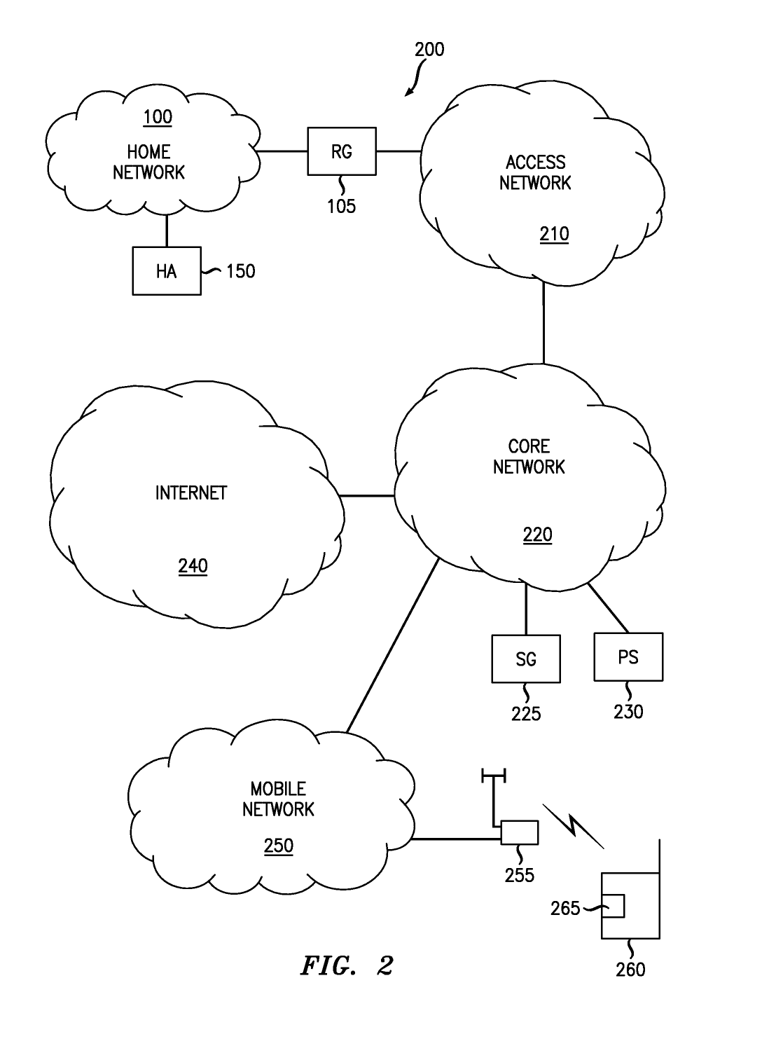

The various components of a home network could be limited to communication only among themselves—within the home (or other installed location), but this is typically not the case. Communication with outside devices is often one of the reasons for which the home network was established. In the embodiment of FIG. 1, home network 100 includes an RG (residential gateway) 105. RG 105 facilitates communications between home network 100 and an access network (not shown in FIG. 1). The access network in turn provides a conduit to a core communication network and then to other networks and devices (see, for example, FIG. 2).

In the embodiment of FIG. 1, RG 105 may also act as a router to receive communications from outside and transmit them to the various components of network 100. In this embodiment, these components include a PC 110 and associated media storage device 115. Telephone service is also available through home network 100, as represented by telephone 140. A set-top box 120 is also part of home network 100 and is associated with DVR 125. In this embodiment, network 100 also includes a telephone 130 and laptop computer 135. As indicated in FIG. 1, many components of network 100 are connected by a cable to RG 105, while the laptop 135 uses a wireless interface. Of course, this particular combination of components, while not uncommon, is exemplary and other home networks may be configured differently.

In accordance with the present invention, home network 100 also includes an HA (home agent) 150, which has several functions that are described in more detail in U.S. patent application Ser. No. 12/985,730, referred to above. HA 150 is typically implemented as a physical processor executing instructions stored as software in a non-transitory medium. In other embodiments, the HA may be implemented as a combination of executable software and hardware such as an ASIC. The HA may be a standalone device or incorporated in a multifunction apparatus that performs other duties as well. In some implementations it may, for example, be implemented in RG 105 or PC 110.

In accordance with this embodiment of the present invention, the HA 150 acquires a UID (unique identifier) that may be used for communications sessions involving FAs authorized to access the home network. There are several ways in which this acquisition could be made; in one embodiment the HA simply generates its own UID, for example using the serial number of the processor. In another embodiment, the HA uses a UID in the OS (operating system). In either case, the UID acquisition scheme should insure the uniqueness of the UID. The UID may also be generated by another element, for example, one could be assigned when registering with an SG (signaling gateway; see for example FIG. 2). If generated by another element, the HA would preferably store it in encrypted form in an accessible memory device.

FIG. 2 is a simplified schematic diagram illustrating selected components of a communication network 200 according to an embodiment of the present invention. Note that communication network 200 actually includes several networks (or, more accurately, components within those networks, which components are not shown separately). For example, home network 100 is illustrated as a cloud (although it is shown in more detail in FIG. 1), except that HA 150 is also depicted in FIG. 2, as is RG 105. RG 105 connects the home network 100 to access network 210. Access network may, for example, be a DSL implementation in a PSTN or a PON (passive optical network). Access network 210 in turns provides a connection to core network 220. In general, core network 220 is a large capacity packet data network that routes communications between many different entities, including home network 100 via access network 210.

In this embodiment, for example, the core network 220 is in communication with the Internet 240, providing home network 100 with Internet access. Again, there may be one or more gateway devices used at the interface, though for simplicity these components are not shown individually in FIG. 2. Separately shown, however, are a signaling gateway (SG) 225 and a proxy server (PS) 230. SG 225 and PS 230 are typically implemented as a physical processor executing instructions stored as software in a non-transitory medium. In other embodiments, the SG and the PS may be implemented as a combination of executable software and hardware such as an ASIC. Each (or both) of these devices could be software executing on a single physical unit or could be implemented using multiple physical devices working cooperatively. The operation of these components in accordance with the present invention will be described below.

In the embodiment of FIG. 2, core network 220 is also connected to mobile network 250. Mobile network 250 typically includes a number of geographically dispersed base stations, each with their own antenna, for communicating with mobile devices in their local area. Antenna/base station 255 is depicted for purposes of illustration. Antenna/base station 255 may include, for example, an eNodeB. Mobile device 260 is also shown and is capable of radio communications with antenna/base station 255 to set up a communication session through mobile network 250. Although only one is shown, a mobile network ordinarily includes a large number of antenna/base stations and employs a protocol for handing over a communication session from one antenna/base station to another when the mobile device relocates.

In this embodiment of the present invention, mobile device 260 includes a FA (foreign agent) 265, which may register with HA 150 in order to access home network 100. In accordance with the present invention a secure communication path, or tunnel, is established between FA 265 of mobile device 260 and HA 150 of home network 100 though SG 225. This process will be explained in more detail below.

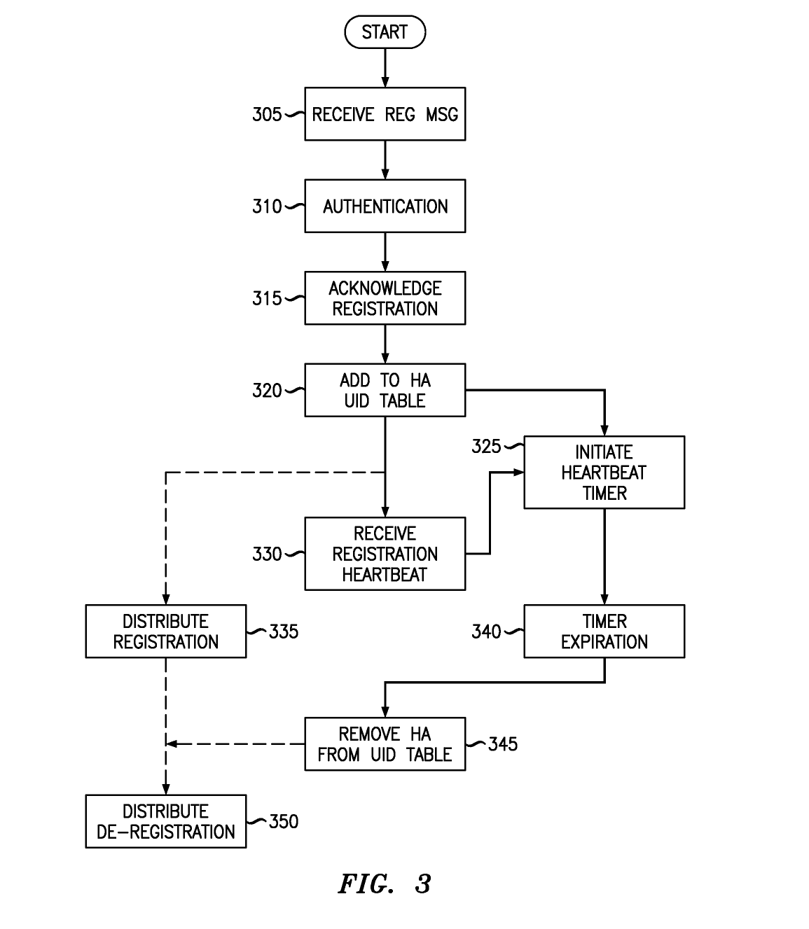

FIG. 3 is a flow diagram illustrating a method 300 according to an embodiment of the present invention. At START it is presumed that the components necessary to performing the method are available and operational according to the present invention. The process then begins when the SG receives a registration message from an HA (step 305). The registration message generally includes the UID of the HA, though in some embodiments (not shown) a UID is provided to the HA during the registration process.

In this embodiment, once the registration message is received in the SG, an authentication protocol is executed (step 310). In a preferred embodiment, the authentication includes a two-way certificate validation between the HA and the SG, with PKI and certificate templates derive from a trusted party, for example a common root or intermediate certificate authority. It is also preferable to check for a CRL should any certificate authority become compromised. Using two-way certificate validation will avoid having to statically provision HAs or additional servers to the SG. The shared virtual IP address of the SG, however, should be provisioned in a secure manner on the Home Agent. The exact procedure used for authentication will depend to some extent on how the HAs are deployed and managed, and no particular authentication method is required by the present invention unless explicitly recited in a particular embodiment.

In the embodiment of FIG. 3, when the authentication procedure has been successfully completed, the SG returns a registration acknowledgement to the HA (step 315). Here it is presumed that the registration process does complete successfully; if it does not the HA may or may not attempt the registration again (not shown), consistent with the parameters of a particular implementation. When successful registration is accomplished, however, the SG adds the UID of the HA to an HA UID table (step 320). The HA UID table also indicates the address at which the HA can be reached.

In this embodiment, once successful registration is acknowledged the SG receives (step 330) a registration heartbeat. The heartbeat is preferably a periodic series of TCP packets sent from the HA to the SG to ensure that TCP flow is maintained in the NAT table for the home network. For each heartbeat message received, the SG transmits an acknowledgement (step 335). This process simply continues until the registration is terminated by either device (not shown), unless the heartbeat fails. In the embodiment of FIG. 3, when the HA is added to the HA UID table of the SG, a heartbeat timer is initiated (step 325). When a heartbeat is received (for example, at step 330) the timer is re-initiated (step 325). Of course, if no heartbeat is received for a period of time, the timer will expire (step 340). When the heartbeat timer expires, the SG removes the HA from the HA UID table (step 345). The period of time between heartbeat timer initiation (or re-initiation) and expiration may vary from implementation, and may be adjusted based, for example on network conditions.

Note that in this embodiment, once the HA is removed form the HA UID table, the SG will not respond to additional heartbeat messages from the HA. In most implementations this means that the HA will have to re-register with the SG (not shown), presuming it wishes to do so.

In some embodiments, a distributed cache system will be used to permit load distribution and provide for redundancy across a multi-server environment. When a change occurs, the primary SG, that is, this SG where the HA first registers, not only updates its mappings (for example, the HA-UID table), but also informs other SGs of the change. In the embodiment of FIG. 3, for example, when the SG adds an HA to the HA-UID table at step 320, it also distributes (step 335) this registration information to other SGs in the multi-server system. The broken line indicates that this step is optional in this embodiment. When performed, however, any of the other SGs in distribution may take over communications with the HA (or with an FA-HA pair) without the need for an additional registration step. Naturally, if the HA is removed from the HA-UID table, the de-registration event is also distributed (step 350).

In a preferred embodiment, use of a version vector (or similar) implementation is made to maintain cache consistency in a distributed environment. For example, an ID can be created for each mapping entry based on a processing-server ID concatenated with a timestamp. In this case, the mapping entry ID is then assigned an initial version of zero and propagated to the other hosts in the network, for example using TCP. Any updates then trigger a version update and distribution. A vector version map may be shared (not shown) periodically to ensure no updates are missing and to assist in updating servers that have flushed their cache (for example, in a reboot).

In some embodiments (not shown), the primary SG may transfer certain monitoring applications to a monitoring app SG. This process is explained in more detail in U.S. patent application Ser. No. 13/077,633 referred to above and is not repeated here except to confirm that the primary SG will preferably retain registration with the HA even when responsibility is transferred.

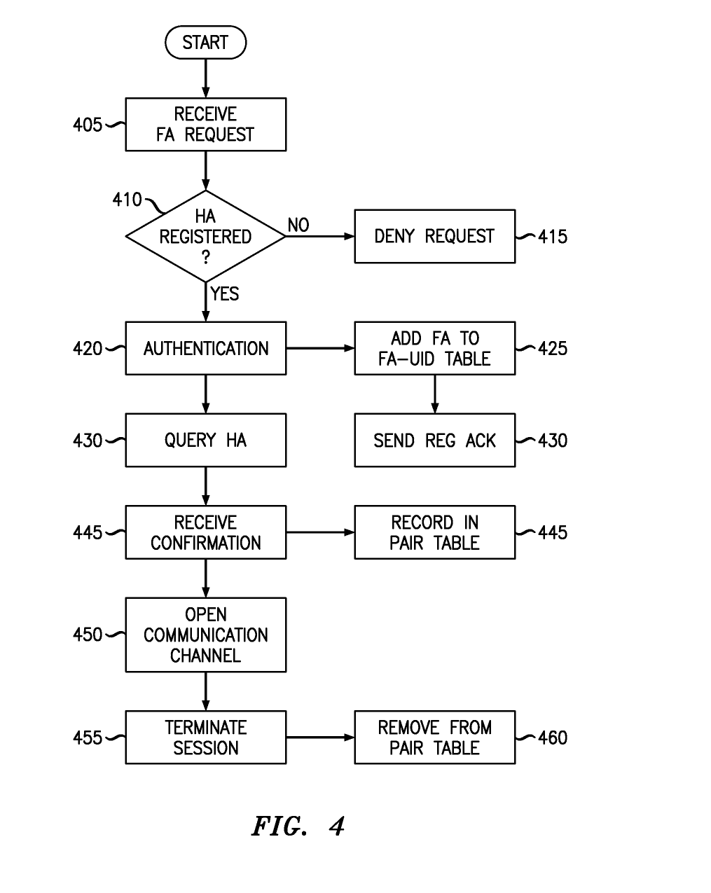

FIG. 4 is a flow diagram illustrating a method 400 according to an embodiment of the present invention. At START it is presumed that the components necessary to performing the method are available and operational according to the present invention. The process then begins when the SG receives a request from an FA to communicate with a home network (step 405). In most implementations, the FA request will identify an HA associated with the home network. The request will usually also include a UID associated with the FA and an authentication certificate. To communicate in accordance with the present invention, the FA presumably would have registered previously with the HA. For example, a mobile device may accomplish this in a home while directly connected by a cable or short-range radio channel to an RG including the HA.

In this embodiment, when the SG receives the FA request, it determines (step 410) if the identified HA is listed in the HA-UID table of the SG. If not, it indicates to the FA that the connection with the home network cannot be made (step 415). It could be, for example, that the FA is not in fact authorized to make the connection, or it may be that the access network connection to the home network is not presently functional. In many instances, however, the HA will be properly registered with the SG. If so, an authentication protocol is executed (step 420). Presuming the authentication is successfully completed, the FA is registered in a FA-UID table (step 425) with the SG and registration is acknowledged (step 430). Note that in a distributed cache environment, distribution of the registration information will also take place but is not shown in FIG. 4. Note also that if authentication fails (not shown) the registration will not occur, though an additional attempt may be made by the FA.

The SG then sends a message (step 435) to the HA with which an FA is attempting to establish a connection. This message may be sent to an address stored in the HA UID table of the SG, and should be able to traverse the NAT boundary, if necessary, which has been kept open by the heartbeat messages. If the HA confirms the SG then receives a message (step 440) from the HA indicating that the connection to the FA may proceed. (Though not separately shown, the HA may of course reject the communication with the FA.)

In this embodiment, once the HA's confirmation is received, the FA-HA pair is recorded in an FA-HA table in the SG (step 445). Since secure connections are now established between the SG and the FA, and between the SG and the HA, the communications between the HA and FA may now proceed (step) until they are terminated (step) by one or both agents, or for some other reason. Here it is noted that there may be a number of FAs that are paired with a HA; though pairing an FA with multiple HAs (at the same time) would not be preferred.

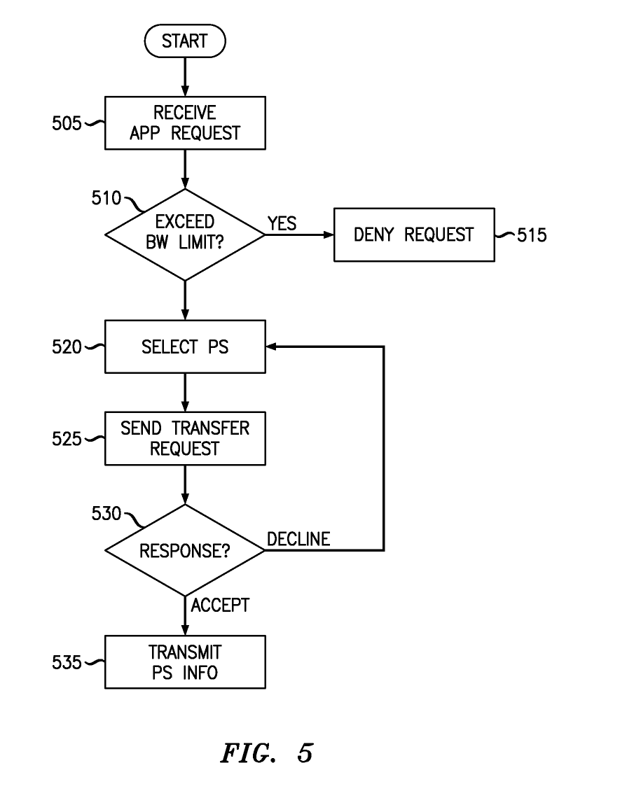

In this way a secure tunnel is established for communication between the FA and the HA. In a preferred embodiment, this channel is used only for low bandwidth communications. If, in this embodiment, there is a need for a higher bandwidth for communication, then the session is transferred to a proxy server. This will no be described in reference to FIG. 5.

FIG. 5 is a flow diagram illustrating a method 500 according to an embodiment of the present invention. At START it is presumed that the components necessary to performing the method are available and operational according to the present invention. It is further presumed that a secure communication channel has been established between an FA and an HA, for example according to the embodiment of FIG. 4, described above. As an example, after the communication session it set up the FA browses the home network for some content that it wishes to download. Having located the content, for example a video of some length, the FA requests that the content be sent. The HA at this point may estimate the bandwidth requirement for streaming the video (and may deny the request based on known bandwidth requirements). Assuming the HA determines the content is available for sending, it forms a request and sends it to the SG.

The process of the embodiment of FIG. 5 then begins with receipt of an HA application request in the SG (step 505). An application request is simply one that indicates a transmission of some bandwidth is about to begin. The threshold for generating such a request is generally imposed by the network, and may be variable depending on, for example, time of day or traffic conditions. Note that is some embodiments, the application request may originate from the FA or some other entity, although in preferred embodiments, approval by the HA is necessary to initiate the request.

In the embodiment of FIG. 5, when the SG receives the application request, it determines (step 510) whether the bandwidth requirement exceeds allowable limits. Note that preferably the request will include an anticipated bandwidth requirement, but if it does not a default requirement will be used. If the request exceeds bandwidth requirements, a message is transmitted (step 515) to the HA informing it that the request is denied. Although not shown, in most implementations that HA is permitted to re-submit the request with a lower bandwidth requirement, or in some cases to negotiate for the higher rate. The OSS/BSS may be queried by the SG (not shown) to determine if a particular bandwidth requirement is permissible for the subscriber associated with the HA. Of course, at times high-bandwidth events may be denied simply due to heavy traffic conditions.

In this embodiment, if the application request does not exceed the then-applicable limit, the SG selects a PS (step 520). The proxy server may, for example, be selected from a PS table in the SG. The amount of the bandwidth requirement and the know traffic load being handled by the PS may be considered in this selection. Once a PS is selected, the SG transmits (step 525) a transfer request message to the selected PS. The transfer request message in this embodiment contains the UIDs of the HA and the FA in addition to the anticipated bandwidth requirements.

In the embodiment of FIG. 5, the SG then awaits receipt of a response from the PS (step 530). If the response is negative, that is, if the PS declines the request, then the process returns to step 520 and another PS is selected and queried. If the PS responds that the transfer will be accepted, then the PS connection information will be transmitted (step 535) to the HA and the FA. Preferably, these devices will not have to register with the PS as the registration may simply be transferred from the SG. It is also preferred that the SG maintains the registration and continue to handle FA-HA communications for control or other low bandwidth purposes. If for any reason assignment of a new PS is necessary, then the assignment process of FIG. 5 is repeated (not shown). This may occur, for example, if the selected PS experiences an outage or the transmission is for some reason interrupted and inadvertently abandoned.

Note that the sequence of operations presented above in reference to FIGS. 3 through 5 are exemplary, and the present invention is not limited to the illustrated embodiments. Additional operations may be added, or in some cases removed, without departing from the spirit of the invention. In additional the operations of the illustrated methods may be performed in any logically-consistent order.

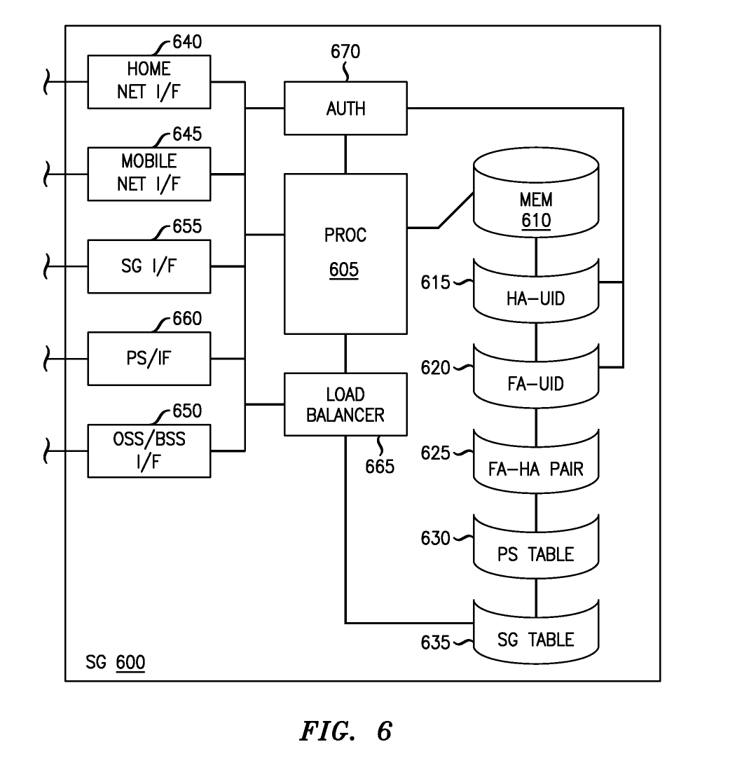

FIG. 6 is a simplified schematic diagram illustrating selected components of an SG 600 according to an embodiment of the present invention. In this embodiment, the SG 600 includes a processor 605 for controlling the other components of SG 600 and a memory device 610, which stores both data and program instructions for controlling the SG 600. Memory device, as used herein, connotes a physical, non-transitory apparatus. Authentication module 670, which may be implemented in hardware or as software executing on hardware, handles authentication of HAs and FAs prior to registration.

Shown separately in FIG. 6 is an HA-to-UID mapping table 615 for storing the identity of each HA registered with the SG 600. Correspondingly, the FA-to-UID mapping table 620 contains a record of each FA that has registered with the SG 600. An FA-to-HA pair table 625 tracks the one-to-one communication sessions that have been established between each FA and each HA registered with the SG 600. Also shown in FIG. 6 is PS table 630 that indicates those proxy servers that are available to handle higher bandwidth communications between the FA-HA pairs. A secondary SG table 635 indicates other SGs to which HA and FA information is to be distributed, and that may be used for load balancing if necessary. Note that if the SG is operating in a distributed-server environment, information related to registration and pairing involving other SGs may be saved at SG 600 as well.

Also depicted in FIG. 6 is a dedicated home network interface 640 though which the SG 600 will communicate with HAs and a mobile network interface 645 for communication with mobile FAs. In a preferred embodiment, separate interfaces are provided to accommodate, for example, different versions of IP. Also shown separately is an OSS/BSS interface 650 though which communication with the OSS/BSS may be handled via a communication network. An SG interface 655 is for communicating with other SGs attached to the network, if any, and a PS interface 660 handles communication with one or more PSs. In this embodiment, a load balancer 665 is also present for determining when communications through the SG should be offloaded. The load balancer may be implemented in hardware or by software running on hardware and is not present in all implementations. When present, it may be located in a location outside the SG 600.

In this manner the present invention facilitates access to a home network using an HA by a remote mobile device having an FA registered with the HA. A secure tunnel may be established between the FA and an SG, and linked with a secure tunnel between the HA and the SG if access is permitted.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of providing remote access via an SG (signaling gateway) for a mobile device comprising an FA (foreign agent) to a home network comprising an HA (home agent), said method comprising:
receiving a registration request from an HA at the SG;
registering the HA;
receiving a heartbeat message from the HA at the SG;
responding to the heartbeat message;
receiving a request directed to the HA from an FA; and
registering the FA.

2. The method of claim 1, further comprising entering the FA-HA pair into an FA-HA pair table at the SG.

3. The method of claim 2, further comprising distributing the HA and FA pair information to at least one other SG.

4. The method of claim 1, further comprising responding by the SG to a heartbeat message received from the FA.

5. The method of claim 1, further comprising, prior to registering the FA, determining whether the HA is registered with the SG.

6. The method of claim 1, further comprising, prior to registering the FA, sending a query to the HA to determine if communication with the FA should be permitted.

7. The method of claim 1, further comprising receiving in the SG an application request from the HA.

8. The method of claim 7, further comprising transferring the FA-HA pair to a PS (proxy server) for communication.

9. The method of claim 8, further comprising, prior to transferring the FA-HA pair, determining whether an anticipated bandwidth requirement in the application request exceeds a bandwidth limit for the HA.

10. A signaling gateway (SG), comprising:
a processor;
a memory device accessible to the processor;
a heartbeat message generator for responding to a received heartbeat message; and
an FA-HA pair table for registering an FA-HA communication pair during a communication session.

11. The SG of claim 10, further comprising a mobile network interface for communicating with FAs via a mobile network and a separate home network interface for communicating with HAs via an access network.

12. The SG of claim 10, further comprising a load balancer for determining when to transfer an FA-HA pair to another SG.
